(19) United States
(12) Patent Application Publication
(10) Pub. No.: US 2006/0257619 A1
(43) Pub. Date: Nov. 16, 2006

(54) Printed synthetic suede leather and a process for preparing the same

(76) Inventors: Roger Milliken, Spartanburg, SC (US); Werner Hoersch, Viersen-Boisheim (DE); Oliver Friedriche, Monchengladback (DE)

Correspondence Address: MILLIKEN & COMPANY, PO BOX 1926, SPARTANBURG, SC, 29303, US

(21) Appl. No.: 10/541,944

(22) PCT Filed: Dec. 18, 2003
(86) PCT No.: PCT/EP03/14541

§ 371 Date: May 5, 2006

(30) Foreign Application Priority Data
Jan. 9, 2003 (DE) 103 00478.5

(51) Int. Cl. B32B 33/00; C09J 7/02; B05D 1/18; B05D 3/02

(52) U.S. Cl. 428/91; 427/372.2; 427/171; 427/434.6

(57) ABSTRACT

The present invention relates to a process for preparing a printed synthetic suede leather, a printed synthetic suede leather obtainable by said process and the use of said synthetic suede leather as a cover in automotive and furniture applications or as outer garments. The process comprises the steps of (a) foaming a composition comprising an aqueous polyurethane dispersion; (b) applying the foamed composition to a printed textile substrate composed of a yarn; (c) coagulating the polyurethane dispersion; (d) drying; and (e) condensation.

The present invention relates to a process for preparing a synthetic suede leather, a synthetic suede leather obtainable by said process and the use of said synthetic suede leather as a cover in automotive and furniture applications or as outer garments.

For design reasons, it is often desired to produce a pattern on a synthetic leather. Such a pattern can be produced by printing the pattern on the synthetic leather by means of different printing techniques. For example, EP-A-904 950 discloses a process for producing a leather-like sheet which comprises the steps of forming a concealing layer on a fibrous base material, forming an easily dyeable layer on said concealing layer, forming an image on said dyeable layer by an ink-jet system, and forming a transparent protective layer on said image.

Against this background, it is the object underlying the present invention to provide a process which can be easily implemented and which provides a synthetic suede leather which is excellent in design effects and is provided with an abrasion-resistant pattern.

The invention solves this problem by a process for preparing a printed synthetic suede leather comprising the steps of
(a) foaming a composition comprising an aqueous polyurethane dispersion;
(b) applying the foamed composition to a printed textile substrate composed of a yarn;
(c) coagulating the polyurethane dispersion;
(d) drying; and
(e) condensation.

The invention further provides a synthetic leather obtainable by this process.

The polyurethane dispersion to be used according to the invention is not particularly limited as long as it is a waterborne dispersion, the term, “polyurethane” also comprising polyurethane polyureas. A survey of polyurethane (PUR) dispersions and processes therefor may be found in Rosthauser & Nachtkamp, “Waterborne Polyurethanes, Advances in Urethane Science and Technology”, vol. 10, pages 121-162 (1987). Suitable dispersions, for example, are also described in “Kunststoffhandbuch”, vol. 7, 2^{nd} ed., Hanser, pages 24 to 26. Preferably, the polyurethane dispersions used according to the invention are polyurethane dispersions suitable for post-curing.

Constituent components of the dispersions used according to the invention may be:

1) Organic di- and/or polyisocyanates such as tetramethylene diisocyanate, hexamethylene diisocyanate (HDI), 2-methyl-pentamethylene diisocyanate, 2,2,4-trimethylhexamethylene diisocyanate (THDI), dodecane methylene diisocyanate, 1,4-diisocyanato cyclohexane, 3-isocyanatomethyl-3,3,5-trimethyl cyclohexyl isocyanate (isophorone diisocyanate=IPDI), 4,4′-diisocyanato dicyclohexyl methane (®Desmodur W), 4,4′-diisocyanato-3,3′-dimethyl dicylohexyl methane, 4,4′-diisocyanato dicyclohexyl propane-(2,2), 1,4-diisocyanato benzene, 2,4- or 2,6-diisocyanato toluene or mixtures of these isomers, 4,4′-, 2,4′- or 2,2′-diisocyanato diphenyl methane or mixtures of these isomers, 4,4′-, 2,4′- or 2,2′-diisocyanato diphenyl propane-(2,2)-p-xylylene diisocyanate and α,α,α,α′-tetramethyl-m or -p-xylylene diisocyanate (TMXDI) as well as mixtures consisting of these compounds. For purposes of modification, small amounts of trimers, urethanes, biurets, allophanates or uretdions of the above mentioned diisocyanates may be used. MDI Desmodur W, HDI and/or IPDI are particularly preferred.

2) Polyhydroxyl compounds-having 1 to 8, preferably 1,7 to 3,5 hydroxyl groups per molecule and a (mean) molecular weight of up to 16,000, preferably up to 4,000. Both defined low-molecular polyhydroxyl compounds such as ethylene glycol, 1,2-, 1,3-propylene glycol, 1,4-butadiol, 1,6-hexadiol, neopentyl glycol, trimethylol propane, glycerine, the reaction product of 1 hydrazine+2 propylene glycol and oligomer or polymer polyhydroxyl compounds having molecular weights of 350 to 10,000, preferably 840 to 3,000 may be contemplated.

Higher molecular hydroxyl compounds comprise the hydroxy polyesters, hydroxy polyethers, hydroxy polythioethers, hydroxy polyacetates, hydroxy polycarbonates and/or hydroxypolyester amides per se known in polyurethane chemistry, preferably those having mean molecular weights of 350 to 4,000, especially preferably those having mean molecular weights of 840 to 3,000. Hydroxy polycarbonates and/or hydroxy polyethers are particularly preferred. By using them, coagulates of particular stability to hydrolysis may be prepared.

3a) Ionic or potentially ionic hydrophilising agents having an acid group and/or an acid group present in form of a salt and at least one isocyanate-reactive group, e.g. OH or NH₂ group. Examples are the Na salt of the ethylene diamine-β-ethyl sulfonic acid (AAS salt solution), dimethylol propionic acid(s) (DMPA), dimethylol butyric acid, aliphatic diols comprising aliphatic diols according to DE-LA-24 46 440, hydroxy pivalic acid or adducts of 1 mol of diamine, preferably isophorone diamine, and 1 mol of an α,β-unsaturated carboxylic acid, preferably acrylic acid (see German patent application 197 50 186.9). Hydrophilising agents of the latter type containing carboxylate and/or carboxyl groups or of dimethylol propionic acid are preferred.

3b) Non-ionic hydrophilising agents in the form of mono- and/or difunctional polyethylene oxide or polyethylene propylene oxide alcohols having molecular weights of 300 to 5000. Especially preferred are n-butanol-based monohydroxy-functional ethylene oxide/propylene oxide polyethers having 35 to 85 wt.-% of ethylene oxide units and a molecular weights of 900 to 2,500. A content of at least 3, especially at least 6 wt. % of non-ionic hydrophilising agents is preferred.

4) Blocking agents for isocyanate groups such as oximes (acetone, butanone or cyclohexanone oxime), secondary amines (diisopropyl amine, dicydlohexyl amine), NH-acidic heterocyclic substances (3,5-dimethylpyrazole, imidazole, 1,2,4-triazole), CH-acidic esters (malonic acid-C₁-C₄ alkyl ester, acetic acid ester) or lactames (ε-caprolactame). Butanone oxime, diisopropyl amine and 1,2,4-triazole are especially preferred.

5) Polyamines as incorporated chain extenders to provide the polymer backbone of the post-curable dispersions specific properties. For example, these include the polyamines discussed under 6) below. The diamino-functional hydrophilising agents discussed under 3a) are also suitable as incorporated chain extenders. Ethylene diamine, IPDA and H₁₂MDA are especially preferred.

6) Polyamine crosslinking agents for post-curing under heat. These are preferably aliphatic or cycloaliphatic diamines, even though trifunctional polyamines or polyamines with higher functions may optionally be used in order to achieve specific characteristics. In general, it is possible to uses polyamines having additional functional groups, e.g. OH-groups. The polyamine crosslinking agents which are not incorporated into the polymer backbone at normal to slightly elevated ambient temperatures, e.g. 20 to 60° C., may be admixed either immediately upon preparation of the reactive dispersions or at any subsequent point in time. Examples of suitable aliphatic polyamines are ethylene diamine, propylene diamine-1,2 and -1,3, tetramethylene diamine-1,4, hexamethylene diamine-1,6, the isomer mixture of 2,2,4- and 2,4,4-trimethyl hexamethylene diamine, 2-methyl pentamethylene diamine and bis-(β-aminoethyl) amine (diethylene triamine).

The constituent components enumerated above are present in the reactive dispersions in the following preferred ranges, the addition of all six components resulting in 100 wt.-% solids content of a dispersion:

| | | | |
|---|---|---|---|
| 1) | Polyisocyanates | 9.0 to 30.0 | wt.-% |
| | Especially preferred | 13.0 to 20.0 | wt.-% |
| 2) | Polyhydroxy compounds | 40.0 to 85.0 | wt.-% |
| | Especially preferred | 55.0 to 75.0 | wt.-% |
| 3a) | Ionic hydrophilising | 0.0 to 5.0 | wt.-% |
| | agent | | |
| | Especially preferred | 2.5 to 4.0 | wt.-% |
| 3b) | Non-ionic | 0.0 to 17.0 | wt.-% |
| | hydrophilising agent | | |
| | Especially preferred | 6.0 to 12.0 | wt.-% |
| 4) | Blocking agent | 0.0 to 5.0 | wt.-% |
| | Especially preferred | 1.5 to 4.0 | wt.-% |
| 5) | Chain-extending | 0.0 to 5.0 | wt.-% |
| | polyamine | | |
| | Especially preferred | 0.0 to 1.5 | wt.-% |
| 6) | Polyamine crosslinking | 0.0 to 6.0 | wt.-% |
| | agent | | |
| | Especially preferred | 2.0 to 4.0 | wt.-% |

The solids content of the PUR dispersion used is preferably at least 40 wt.-%, more preferably at least 50 wt.-% and especially at least 65 wt.-%.

Suitable PUR dispersions are described in DE 198 56 412 A1. PUR dispersions preferably used in the invention include Tubicoat PU80 (manufacturer/supplier: CHT R. Beitlich-GmbH, Tübingen), Witcobond W-293 (67% solids content) and Millikogate 1200 (Milliken, U.S.A.).

In addition, a composition used in the invention preferably contains one or more substances which, as a rule, ensure uniform coagulation of the polyurethane when the temperature is raised. This substance, the coagulant, usually is a salt or an acid causing coagulation of the polyurethane under certain conditions such as a certain temperature, for example ammonium salts of organic acids such as Tubicoat-Koagulant AE 24% (available from CHT R. Beitlich GmbH, Tübingen). These substances also comprise an acid-generating chemical agent, i.e. a substance which is not an acid at room temperature, but turns into an acid after heating. Specific examples for such compounds include ethylene glycol diacetate, ethylene glycol formate, diethylene glycol formate, triethyl citrate, monostearyl citrate and an organic acid ester available from Highpoint Chemical Corporation under the trade name Hipochem AG-45. The coagulant is preferably present in the composition in an amount of 1 to 10 wt.-% based on the solids content of the polyurethane dispersion.

In addition, the composition used according to the invention may contain a surfactant which, when heated, is less water-soluble than at room temperature. Such a surfactant binds to the polyurethane latex upon gelation and facilitates the uniform coagulation of the latex over the entire surface of the textile substrate over which it is applied. Specific surfactants meeting these requirements include polyethylene oxides, poly(ethylene/propylene) oxides, polythioethers, polyacetales, polyvinyl-alkyl ethers, organopolysiloxanes, polyalkoxylated amines and derivatives of such compounds, polyalkoxylated amines available from Clariant under the trade name Catafix U® being preferred.

In accordance with the invention, the substances for coagulation and the pertinent process steps for coagulation as described in U.S. Pat. No. 5,916,636, U.S. Pat. No. 5,968,597, U.S. Pat. No. 5,952,413 and U.S. Pat. No. 6,040,393 may be used.

In addition, the composition used according to the invention preferably contains a foaming agent, generally a surfactant, preferably a non-ionic surfactant such as alkyl amine oxide, or an anionic surfactant, such as ammonium stearate, e.g. the foamer Tubicoat AOS from CHT R. Beitlich GmbH, Tübingen. The amount of the foaming agent used is selected in such a manner that a foam is provided which remains stable after application to the textile substrate, preferably until coagulation. In general, the amount is 0.01 to 10 wt.-%, preferably 1 to 10 wt.-% based on the solids content of the polyurethane dispersion.

Furthermore, the composition of the invention may contain foam stabilisers. Known compounds may be used as foam stabilisers (B), for example water-soluble fatty acid amides, hydrocarbon sulfonates or saponaceous compounds (fatty acid salts), for example compounds wherein the lipophilic radical contains 12 to 24 carbon atoms; especially alkane sulfonates having 12 to 22 carbon atoms in the hydrocarbon radical, alkyl benzosulfonates having 14 to 24 carbon atoms in the entire hydrocarbon radical or fatty acid amides or saponaceous fatty acid salts of fatty acids having 12 to 24 carbon atoms. The water-soluble fatty acid amides are preferably fatty acid amides of mono- or di-(C₂₋₃-alkanol) amines. For example, the saponaceous fatty acid may be an alkali metal salt, amine salt or unsubstituted ammonium salt. Known compounds are generally considered as fatty acids, such as lauric acid, myristic acid, palmitic acid, oleic acid, stearic acid, ricinoleic acid, behenic acid or arachic acid, or technical fatty acids such as coconut fatty acid, tallow fatty acid, soy fatty acid or technical oleic acid as well as hydrogenation products thereof. Especially preferred are unsubstituted ammonium-salts of higher saturated fatty acids, especially those having 16 to 24 carbon atoms, primarily stearic acid and hydrogenated tallow fatty acid. The foam stabilisers should be of the kind which decompose neither under foaming conditions nor under application conditions. Suitable ammonium salts are those having a decomposition temperature of ≧90° C., preferably ≧100° C. if desired, the more weakly anionic stabilisers (B₁), especially the carboxylic salts or the amides, may be combined with the more strongly anionic surfactants (B₂), especially with the above-mentioned sulfonates or preferably fatty alcohol sulfates, advantageously in the form of salts thereof (alkali metal or ammonium salts as mentioned above), for example at a (B₁)/(B₂) weight ratio in the range of 95/5 to 50/50, advantageously 85/15 to 65/35.

The composition used according to the invention preferably also contains plasticisers, thickening agents, fixing agents, emulsifiers, flame retardants, pigments and/or sunscreens.

Suitable plasticisers are the substances listed in A. K. Doolittle, “The Technology of Solvents and Plastizisers”, J. Wiley & Sons. Ltd. Polymer plasticisers are preferably used, for example Tubicoat MV (available from CHT R. Beitlich GmbH, Tübingen), The amount of plasticiser should be as low as possible in order to ensure good abrasion resistance of the final product. The plasticiser is preferably used in an amount of up to 10 wt.-% based on the total weight of the composition, more preferably 2 to 7 wt.-%.

Suitable thickening agents are common thickening agents such as polyacrylic acids, polyvinyl pyrrolidones or cellulose derivatives such as methyl cellulose or hydroxy ethyl cellulose, e.g. Tubicoat HEC (available from CHT R. Beitlich GmbH, Tübingen).

Fixing agents preferred for the invention are aminoplasts or phenolic resins. Suitable-aminoplasts or phenolic resins are the well-known commercial products (cf. “Ullmanns Enzyklopädie der technischen Chemie”, vol. 7, 4^{th} edition, 1974, pages 403 to 422, and “Ullmann's Encyclopedia of Industrial Chemistry, vol. A19, 5^{th} ed., 1991, pages 371 to 384.

The melamine-formaldehyde resins are preferred, replacement of 20 mol-% of the melamine with equivalent amounts of urea being possible. Methylolated melamine is preferred, for example bi-, tri- and/or tetramethylol melamine.

The melamine-formaldehyde resins are generally used in powder form or in the form of their concentrated aqueous solutions which have a solids content of 40 to 70 wt.-%. For example, Tubicoat Fixierer HT (available from CHT R. Beitlich GmbH, Tübingen) may be used.

As emulsifiers, the composition used in the invention may contain alkyl sulfates, alkyl-benzene sulfonates, dialkyl sulfosuccinates, polyoxyethylene alkyl phenyl ether, polyoxyethylene acyl ester and alkyl aryl polyglycol ether such as Tubicoat Emulgator HF (available from CHT R. Beitlich GmbH, Tübingen) or fatty acid salts in the form of their alkali or ammonium salts.

Suitable flame retardants are antimony trioxide Sb₂O₃, antimony pentoxide Sb₃O₃, alumina hydrate Al₂O₃.3H₂O, zinc borate Zn(BO₂)₂.2H₂O or 2ZnO (B₂O₃)₃.(H₂O)_{3,5}, ammonium ortho- or polyphosphate NH₄H₂PO₄ or (NH₄PO₃)ₙ and chloroparaffines.

Especially preferred are the phosphonic acid esters, particularly 5-ethyl-2-methyl-1,3,2-dioxaphosphorinane-5-yl) methyl phosphonate-P-oxide and bis(5-ethyl-2-methyl-1,3,2-dioxaphosphorinane-5-yl) methyl methyl phosphonate-P,P′-dioxide.

The composition comprising the PUR dispersion may further contain pigments in an amount which is not detrimental to the appearance of the pattern printed on the textile substrate. The pigments may be added both before and after foaming, preferably before foaming. Pigments used in the invention are described in Ullmann's Encyclopedia of Industrial Chemistry, 5^{th} ed., 1992, vol. A20, pages 243 to 413. The pigments used in the invention may be inorganic or organic pigments. The light-fastness of the pigments used should be as high as possible and is preferably in the range of the light-fastness of the pigments Bezaprint, e.g. Bezaprint Gelb RR (yellow), Bezaprint Grün B (green), Bezaprint Rosa BW (pink), Bezaprint Braun TT (brown), Bezaprint Violett FB (purple), Bezaprint Rot KGC (red), Bezaprint Blau BT (blue) and Bezaprint Blau B2G (blue) (all available from Bezema AG, Montlingen, Switzerland), PIGMATEX Gelb 2 GNA (60456), PIGMATEX Gelb K (60455), PIGMATEX Fuchsia BW (60416), PIGMATEX Marine RN (60434), PIGMATEX Braun R (60446), PIGMATEX Schwarz T (60402) (all available from SUNChemical, Bad Honnef, Germany), Oker E.M.B. (Ref. 3500), Rot-Violett E.M.B. (Ref. 4406), Braun E.M.B. (Ref. 5550), und Blau E.M.B. (Ref. 6500) (all available from EMB NR, Bronheim, Belgieum), which are especially preferred for the invention. The light-fastness values are preferably at least 6, more preferably at least 7 (blue scale; 1 g/kg, see DIN 75 202).

Sunscreens such as bis(1,2,2,6,6-pentamethyl-4-piperidyl) sebacate and methyl-1,2,2,6,6-pentamethyl-4-piperidyl sebacate, UV absorbers and sterically hindered phenols may also be included in the composition used according to the invention.

The textile substrate of a yarn used according to the invention is not particularly limited. Especially preferred are yarns with fine filament yarns which preferably have an average titer of individual filaments of 2.5 denier or less, preferably 0.01 to 1.6 denier, and especially 0.6 to 1.4 denier. Moreover, polyester yarns are preferred.

Particularly useful yarns include for example flat or textured polyester yarns with filament titers of 0.6 denier to approximately 1.4 denier, e.g. flat or textured (e.g. false twist textured) polyester filament yarns. Moreover, yarns made of components having different shrinkage degrees may also be suitable to enhance the handle properties.

For yarns which do not contribute to the formation of the covering (appearance, handle properties) the titer is not relevant (see e.g. Example 2, guide bar 3).

Furthermore, textile substrates of micro-split yarn may be used, the micro-fibres preferably having a titer in the range of 0.01 to 0.4 denier, more preferably in the range of 0.08 to 0.25 denier. For example, the micro-fibres are prepared as follows. First a multi-component fibre of at least two polymers is formed by a process comprising mixing and melting the at least two polymers having low compatibility and mutual solubility and then spinning said molten mixture; or by a process comprising melting at least two polymers having no compatibility or mutual solubility and then combining them near a spinning jet and spinning them. In the multi-component fibre thus obtained, at least one polymer forms a disperse phase (“island component”, i.e. the micro-fibre component) and the other polymer forms the phase of the dispersing-medium (“sea component”). The micro-fibres (“islands”) may consist of polyester-such as polyethylene terephthalate, 6- or 6,6-polyamide, cotton, cotton/polyester blends, wool, ramie or Lycra, preferably polyester, while the “sea” or the fibre jacket may be present in the form of a polystyrene, styrene copolymer, polyethylene, ethylene propylene copolymer, sodium sulfoisophthalic acid, copolymerised polyester matrix or a mixture thereof. The filaments may have the following characteristics: 1.4 to 10 denier, preferably 3.4 to 3.8 denier, stretch ratio 2:1 to 5:1, 4 to 15 crimps per cm. In addition, the filaments may contain 4 to 14 parts by weight of a micro-fibre, 20 to 50 parts by weight of matrix and, optionally, about 3 parts by weight of polyethylene glycol, the latter being contained in the matrix. As a rule, the filaments are processed into a felt which is then needled in order to obtain a needle-felt having a density of 0.15 to 0.35 g/cm³. The needle-felt is than immersed in a splitting bath, for example an aqueous solution of polyvinyl alcohol, a halogenated hydrocarbon or a 3% NaOH solution, depending on the nature of the “sea” component. The product obtained is dried and represents an example for a textile substrate used in accordance with the invention.

The textile substrate made of a yarn may be a woven fabric, a non-woven fabric, a knitted fabric or a warp-knit, the latter being preferred. Preferred textile substrates comprise the textile fabrics described in EP 0 584 511 B1 and EP 0 651 090 B1.

The textile substrate on which a pattern is printed may be an untreated-white substrate or a pre-dyed substrate. For pre-dying, disperse dyes for post-aging lightfast textiles are preferably used for this purpose, most preferably the dyes of the Terasil H® brand made by Ciba and the dyes of the Resolin® brand made by Bayer. The light-fastness of the disperse dyes used is preferably in the range of these branded dyes.

The pattern present on the textile substrate may be obtained by any common printing process, preferably by a flat or rotary screen printing process. This printing process results in a printed pattern on the textile substrate. The printed pattern is preferably a multicolor design. If the printed pattern is single-colored, the printed pattern preferably resembles the grain structure of a suede-type leather, i.e. the single color is applied with different color depths such that a grain-like pattern is obtained. The dyes are preferably disperse dyes such as those which are generally applied for printing on polyester (see for example J. F. Dawson; “The structure and properties of disperse dyes for polyester coloration”, J. Soc. Dyers Colour. 99 (1983), 183). The light-fastness of the disperse dyes used is preferably in the range of the dyes of the Terasil H® brand made by Ciba and the dyes of the Resolin® brand made by Bayer. Moreover, the printing pastes preferably show the stability and adhesive properties required for polyester printing.

The textile substrate is preferably capable of being dyed or printed using a Millitron® jet dye machine, a superior form of jet dyeing of textile in a pixelated fashion, marketed by Milliken & Company of LaGrange, Ga.

Technologies relating to such a jet dying machine have been disclosed in U.S. Pat. Nos. 3,894,413, 4,116,626, 5,136,520, 5,142,481, 5,208,592 and 6,120,560.

In the devices and techniques described in the above-referenced U.S. patents, the pattern is defined in terms of pixels, and individuial colorants, or combinations of colorants, are assigned to each pixel in order to impart the desired color to that corresponding pixel or pixel-sized area on the substrate. The application of such colorants to specific pixels is achieved through the use of hundreds of individual dye applicators, mounted along the length of color bars that are positioned across the path of the moving substrate to be patterned. Each applicator in a given color bar is supplied with colorant from the same colorant reservoir, with different arrays being supplied from different reservoirs, typically containing different colorants. By generating applicator actuation instructions that accommodate the position of the applicator along the length of the color bar and the position of the color bar relative to the position of the target pixel on the moving substrate, any available colorant from any color bar (disperse dyes, particularly the ones mentioned above, being preferred) may be applied to any pixel within the pattern area on the substrate, as may be required by the specific pattern being reproduced.

With reference to U.S. Pat. No. 6,120,560 one exemplary embodiment of printing or dyeing of a textile substrate is described. A textile substrate to be patterned is first subjected to a pre-steamer, which serves to bulk the yarn in the substrate in preparation for the solid shade dyeing at the next stage. The solid shade dyeing stage may be carried out using various commercially available devices, so long as the devices are capable of uniformly applying and fixing a dye to a textile substrate in a single step.

It has been found most effective for subsequent multicolour patterning if the color chosen during the solid shade dyeing step is relatively light and relatively neutral. Accordingly, light shades of grey or beige, particularly the latter, are preferred, although other colours and shades may be preferable, depending upon the palette of colours to be used in the patterning step and the over all patterning effect desired. The solid shade dyeing step may be eliminated or skipped or that the yarn may be yarn dyed or solution dyed, Beck dyed, or the like. Also, a white or off white yarn may go straight to the wet out application or patterning device and skip any solid shade dyeing or vacuuming.

Following the uniform application and fixing of dye on the substrate in the solid shade dyeing step (if any), the substrate is next passed over a vacuum slot or other means to remove excess moisture, such as water and condensation resulting from the dyeing operation. Following this step, the substrate is prepared for the pattern dyeing step by the application of surfactants and other chemicals useful in achieving deep color penetration and distinct patterns when the patterns are applied to the substrate using highly localised, discrete streams or drops of ambient temperature liquid dye. The exact mix of chemicals at this point will depend upon a number of factors, including the nature of the substrate, the nature and operating parameters of the patterning device used, the nature and viscosity of the dye, and other factors. The manner in which these chemicals are applied is not critical, so long as the degree of wet pickup is satisfactory and the previously dyed surface is not adversely affected. Depending upon the results of this step, an additional, optional vacuuming stage or the like may be used to remove excess moisture from the substrate prior to patterning.

Following these steps the substrate is introduced to a dye jet patterning device. The substrate is passed over a roll and onto a conveyer system that allows the substrate to pass before a series of dye applicator arrays. Each array is fed from a separate dye supply system, and preferably applies a different color dye. Typically eight arrays would provide for the use of an eight process color palette. A great many more than eight colours can be generated on the substrate, due to various colours mixing and blending techniques. The details of the patterning device are not believed to be critical. Usually, both the substrate, as it passes through patterning device and the dye applied to the substrate in the patterning device are essentially at ambient temperature. No effort is made to introduce thermal or other forms of energy into the dyeing process in an effort to fix, either fully or partially, any of the patterning dye until the patterning of the substrate is complete and the substrate leaves the patterning device.

The patterning device may be a patterning device as shown in U.S. Pat. No. 3,894,413 comprising a jet dyeing apparatus including a supply table, jet applicator, steam chamber, water washer, hot air dryer, and collection table. Following this patterning operation, the substrate is sent, in turn, to a steamer, in which the dyes applied during the patterning step are fixed, then to a washer, where excess dyeing chemicals may be removed, and finally to a dryer, where the substrate may be dried. It has been found that postponing the fixing of the patterning dye until the patterning is complete provides an opportunity to create an extremely rich and broad variety of color effects due to the ability to mix and blend different dyes after they have been deposited on the substrate. For example, an area on the substrate carrying unfixed dye from one of the applicator arrays can be the target of a different color dye from another of the applicator arrays, thereby providing for the in situ blending of the two different unfixed dyes. Similarly, the target for the different color dye can be selected near the edge of a previously dyed area, thereby providing for in situ dye diffusion primarily along a boundary between the two unfixed dye areas.

Subsequently, the dye is fixed within the fibers. Said fixation is preferably carried out by high temperature (HT) steam fixation (5 to 11 min; 170 to 180° C.) or by thermosol fixation (dry heat; 30 sec to 2 min at 190 to 210° C.). HT steam fixation is preferred, most-preferred is HT steam fixation at 180° C. for 8 min dwell time.

The fixation step is followed by washing and drying steps.

The obtained printed pattern is preferably such that the color penetrates into the fabric. In the case of multi-layered fabrics, the color preferably penetrates through at least the first layer, the first layer being generally the top visible layer which determines the appearance and handle properties. In the case of pile fabrics, the printed color is preferably present both in the pile and the base. In a particularly preferred embodiment, the printed pattern is also discernible on that side of the fabric which is opposite to the printing side.

The printed pattern shows a high abrasion resistance. Preferably, the printed pattern is still visible after 35.000 rubs, more preferably after 50.000 rubs, and most preferably after 60.000 rubs (Martindale test; determined according to EN ISO 12947-1 and -2; 1998); The abrasion resistance of the pattern can be controlled inter alia by the pressure applied during printing and the viscosity of the printing paste.

The printed, textile substrate is then ready for the application of the polyurethane foam.

The individual steps of the process according to the invention are described in detail below.

The composition comprising the polyurethane dispersion and, optionally, the pigments is first foamed. For this purpose, the composition may be foamed mechanically. This may be carried out in a foam mixing device under application of high shear forces. Foaming in a foam generator by blowing in pressurised air is another alternative. A Stork mixer or a foam processor, e.g. the Stork FP3 foam-processor, is preferably used. Foaming is carried out in such a manner that the foam density obtained is preferably 250 to 600 g/l, especially preferably 300 to 500 g/l.

The foamed composition is then applied to the substrate with common coating devices, for example a blade such as a doctor blade, rollers or other foam application devices.

Blade devices, for example of the type described in EP 0 879 145 B1 or EP 0 828 610 B1, are preferred. The use of a closed squeegee system, preferably with an exchangeable squeegee blade such as the Stork Rotary Screen Coating Unit CFT is especially preferred. Application may be carried out on one side or both sides. The amount applied is selected in such a manner that the weight increase after condensation is at least 20%, preferably 30 to 40%, based on the textile substrate, e.g. 33%. The amount applied per m² may be influenced via the pressure in the closed squeegee system or by the mesh number of the screen. The wet weight applied preferably corresponds to the weight of the textile substrate. The foam decomposition rate on the substrate depends on the type and amount of the foaming agent. Preferably, the foam collapses completely during the time span between application and steam coagulation, said time span depending on the distance to be covered in the device and the speed of the process. Moreover, the foam should collapse before the polyurethane is dry.

While the polyurethane foam has a preferred foam density of 250 to 600 g/l, especially preferred being 300 to 500 g/l, as noted above, the density of the polyurethane coating after collapse is preferably in the range of 650 to 1000 g/l, more preferably 800 to 1000 g/l.

The manner in which coagulation is effected depends largely on the chemical composition of the dispersion used in the invention and, particularly, on the type of coagulant if present. For example, coagulation may be carried out by evaporation coagulation or by salt, acid or electrolyte coagulation. As a rule, coagulation is effected by a temperature increase. For example, the composite material of a textile substrate and foam may be subjected to a short heating treatment with heated steam, for example 1 to 10 sec. at 100 to 110° C. This is especially preferred when ammonium salts of organic acids are used as coagulants. On the other hand, if the above-mentioned acid-generating chemicals are used as coagulants, coagulation preferably takes place in the manner described in U.S. Pat. No. 5,916,636, U.S. Pat. No. 5,968,597, U.S. Pat. No. 5,952,413 and U.S. Pat. No. 6,040,393, respectively.

After coagulation, drying and condensation is carried out. The drying may take place either at a temperature below the cross-linking temperature or at a temperature above the cross-linking temperature. In the latter case, the drying and condensation steps coincide.

If the drying and the condensation are carried out in separate steps, drying is firstly effected at a temperature below the cross-linking temperature, preferably below 140° C., more preferably at 80 to 100° C. Drying may be carried out in any conventional dryer. However, drying in a microwave (HF) dryer is preferred, since evaporation does not take place on the surface, but uniformly throughout the entire composite material, which counteracts the formation of a film on the surface.

Subsequently, the condensation is carried out in a temperature range above the cross-linking temperature preferably at 140 to 200° C., more preferably at 165 to 175° C., contact time being selected in a manner to ensure sufficient condensation of the PU component.

Alternatively, drying and condensation in a single step may follow the coagulation by heating directly at a temperature above the cross-linking temperature, preferably at 140 to 200° C., more preferably at 165 to 175° C., contact time being selected in a manner to ensure sufficient drying and sufficient condensation of the PU component.

The dried textile substrates may be subjected to surface treatment before, during or after condensation, for example by sanding, sueding, raising and/or tumbling. It is particularly preferable to sand and, additionally, to perform a mechanical treatment in a tumbler (which may be either operated continuously or in batch mode) after the condensation step, since this may improve the handle and surface characteristics considerably.

Alternatively, it is especially preferred to conduct the condensation under mechanical stress, for example in a tumbler.

After condensation, the synthetic suede leather obtained may be subjected to post-treatment, the type of such post-treatment depending on the desired surface appearance. In case of a “peach skin” or similar surfaces, i.e. a very dense, but short pile, a sanding/sueding process is conducted, whereas a raising process is conducted if a somewhat longer pile is desired.

After that, final stentering to a defined width is carried out.

The invention also provides a synthetic suede leather which may be obtained by the above-mentioned process. The synthetic suede leather of the present invention is preferably highly abrasion-resistant and shows an excellent air permeability. The synthetic suede leathers preferably show no specimen breakdown after 35.000, more preferably 50.000, most preferably 60.000 rubs (determined in accordance with EN ISO 12947-1 and -2; 1998). Specimen breakdown is observed when the pile of the fabric is abraded. The synthetic suede leathers further preferably show an air permeability in the range of 10 to 30 cm³/cm² sec, more preferably 15 to 25 cm³/cm² sec (determined according to ASTM D737-96).

The present invention also provides a synthetic suede leather which may be obtained by the above-mentioned process except that a non-printed-textile substrate is used in step (b), rather than a printed textile substrate. The corresponding synthetic suede leather shows an abrasion-resistance and air permeability as defined above with regard to a synthetic suede leather derived from a printed textile substrate.

The present invention further provides the use of the above-described synthetic suede leather as a cover in automotive, upholstery and furniture applications or as outer garments.

### EXAMPLES

### Example 1

Starting Material: 3-Bar Warp-Knitted-Fabric

Guide bar 1: 7.1 wt.-% of 33 f 16T616 Trevira (33 dtex in 16 single, titres, type 616).
Guide bar 2: 84.7 wt.-% of 160f 64×12 text (160 dtex in 64 single titres each of which may be splitted into 12 single titres by post-treatment, corresponding to a single titre of 0.208 dtex)
Guide bar 3: 8.2 wt.-% as for guide bar 1.

All yarns are undyed.

Path of Treatment:

1. 1× pre-raising on 7 tambour cylinders
2. 1× raising and shearing
3. Dyeing with selected disperse dyes as formulated
4. Drying

An image is then printed on the textile substrate. After drying and fixation, the textile substrate is ready for coating (weight per unit area 300 g/m²).

Then a composition for application was prepared by mixing the following components (all in parts by weight).

| | | |
|---|---|---|
| Tubicoat thickening agent HEC | 1 | part |
| Tubicoat PU 80 | 751 | parts |
| Tubicoat plasticiser MV | 100 | parts |
| Tubicoat foamer AOS | 50 | parts |
| Tubicoat fixing agent HT | 20 | parts |
| Tubicoat coagulant 24% AE | 35 | parts |
| Tubicoat emulsifier HF | 20 | parts |
| Tinuvin (Ciba B 75) (special sunscreen | 20 | parts |
| for polymers) | | |
| Ammonia | 3 | parts |
| Total | 1000 | parts |

All of the products of the “Tubicoat” series are available from CHT R. Beitlich GmbH, Tübingen, Germany.

This coating liquid is fed into a Stork FP 3 foam processor where an instable foam having a relative density of about 400 g/l is produced. Said foam is fed directly into a closed squeegee system of the Stork Rotary Screen Coating Unit CFT.

At a pressure of 2 bar in the closed squeegee system and a mesh number of the screen of 40, a overall weight per unit area of (textile substrate+coating) of 400 to 410 g/m² is obtained.

After application of the coating, the article is subjected to a very brief, but intense steam treatment (about 4 sec. at 102° C.) which causes spontaneous coagulation. After coagulation, the article is pre-dried at a temperature below the cross-linking temperature of 140° C. at 90° C. and folded.

Condensation of the pre-dried coating takes place under pressure at about 6% relative humidity and 140° C. and a rotation speed to 600 m/min. for 30 min. in a HT tumbler (by Thies Coesfeld in the present case).

After that, the coating process as such is completed.

The manner of any subsequent surface-treatment depends on the desired appearance of the surface. In case of a surface similar to “peach-skin”, i.e. a very dense, but short pile, a sueding process is carried out while a raising process is used when a somewhat longer pile is desired. Final stentering to a defined width is the last step of the process.

### Example 2

Starting Material: 3-Bar Warp-Knitted Fabric

Guide bar 1: 45f32T-611 flat 33.4%—Trevira
Guide bar 2: 45f32T-611 flat 45.7%—Trevira (alternatively: 83f136 micrell; textured—polyester)
Guide bar 3: 50f20T-610 flat 20.9%—Trevira

All yarns are undyed.

Path of Treatment:

1. 1× pre-raising on 7 tambour cylinders
2. 1× raising and shearing
3. Dyeing with selected disperse dyes as formulated
4. Drying

An image is then printed on the textile substrate. After drying and fixation, the textile substrate is now ready for coating (weight per unit area 250 g/m²).

Then a composition for application was prepared by mixing the following components (all in parts by weight).

| | | |
|---|---|---|
| Water | 90 | parts |
| Tubicoat thickening agent HEC | 1.5 | parts |
| Tubicoat PU 80 | 807 | parts |
| Tubicoat plasticiser MV | 60 | parts |
| Tubicoat foamer AOS | 40 | parts |
| Tubicoat fixing agent HT | 20 | parts |
| Tubicoat coagulant 24% AE | 35 | parts |
| Ammonia | 3 | parts |

All of the products of the “Tubicoat” series are available from CHT R. Beitlich GmbH, Tübingen, Germany.

This coating liquid is fed into a Stork FP 3 foam processor where an instable foam having a relative density of about 300 g/l is produced. Said foam is fed directly into a closed squeegee system of the Stork Rotary Screen Coating Unit CFT.

At a pressure of 2.4 bar in the closed squeegee system and a mesh number of the screen of 25, an overall weight per unit area of (textile substrate+coating) of 270 to 350 g/m² is obtained.

After application of the coating, the article is subjected to a very brief, but intense steam treatment (about 4 sec. at 102° C.) which causes spontaneous coagulation. After coagulation, the article is dried at a temperature of 175° C. and folded.

Subsequently, a surface treatment, e.g. sanding/sueding or raising and a tumble process, as described above in Example 1, is carried out.

After that, the coating process as such is completed.

Final stentering to a defined width is the last step of the process.

1. A process for preparing a printed synthetic suede leather comprising the steps of
(a) foaming a composition comprising an aqueous polyurethane dispersion;
(b) applying the foamed composition to a printed textile substrate composed of a yarn;
(c) coagulating the polyurethane dispersion;
(d) drying; and
(e) condensation.

2. A process according to claim 1, characterised in that the composition contains a coagulant.

3. A process according to claim 2, characterised in that the coagulant is an acid or a chemical substance capable of generating an acid.

4. A process according to any of the preceding claims, characterised in that the composition contains a foaming agent.

5. A process according to any of the preceding claims, characterised in that the yarn has a count of 0.01 to 2.50 denier.

6. A process according to any of the preceding claims, characterised in that the fibres of the yarn consist of polyester.

7. A process according to any of the preceding claims, characterised in that the foaming is carried out in such a manner that a foam density of 250 to 600 g/l is obtained.

8. A process according to any of the preceding claims, chatacterised in that the polyurethane has a density of 800 to 1000 g/l after drying and condensation.

9. A process according to any of the preceding claims, characterised in that the printed textile substrate has a pattern obtained in a rotary screen printing process.

10. A process according to any of the preceding claims, characterised in the printed textile substrate has been fixed with steam at a temperature in the range of 150 to 200° C.

11. A process according to any of the preceding claims, characterised in that the foamed composition is applied in a closed squeegee system.

12. A process according to any of the preceding claims, characterised in that the composition is applied in such an amount that the weight per unit area is increased by 20 to 40% vis-à-vis the textile substrate.

13. A process according to any of the preceding claims, characterised in that the textile substrate is subjected to mechanical stress before, during or after the condensation phase.

14. A process according to claim 13, characterised in that the mechanical stress is applied during the condensation phase through a tumble process.

15. A synthetic suede leather obtainable according to the process of any of the preceding claims.

16. A synthetic suede leather obtainable by applying a foamed polyurethane dispersion on a textile substrate composed of a yarn and subsequently coagulating said dispersion, the leather showing no specimen breakdown after 35.000 rubs (determined in accordance with EN ISO 12947-1 and -2) and having an air permeability in the range of 10 to 30 cm³/cm² sec (determined in accordance with ASTM D-737-96).

17. The use of the printed synthetic suede leather according to claim 15 or 16 as a cover in automotive, furniture or upholstery applications or as outer garments.
